(19) United States
(12) Patent Application Publication
(10) Pub. No.: US 2016/0285832 A1
(43) Pub. Date: Sep. 29, 2016

(54) SECURE CONSUMPTION OF PLATFORM SERVICES BY APPLICATIONS

(71) Applicants: Petar D. Petrov, SOFIA (BG); Petio Petev, SOFIA (BG); Nikolai Tankov, SOFIA (BG)

(72) Inventors: Petar D. Petrov, SOFIA (BG); Petio Petev, SOFIA (BG); Nikolai Tankov, SOFIA (BG)

(21) Appl. No.: 14/665,362

(22) Filed: Mar. 23, 2015

(51) Int. Cl. H04L 29/06; H04L 29/08

(52) U.S. Cl. CPC H04L 63/0428; H04L 67/2871; H04L 67/32; H04L 67/141

(57) ABSTRACT

A proxy server is instantiated on an application virtual machine of a cloud platform. The application virtual machine hosts an application that consumes services. The proxy server manages requests by the application for secure consumption of the services. The proxy server receives first requests from the application for consumption of a service. The application refers to the service by an identification. The proxy server determines a real network address for accessing the service by searching in a service catalog storing a mapping between the identification and the real network address. The proxy server requests execution of consumption of the service. The proxy server establishes a secure communication having mutual authentication with the service through generating an encrypted second request directed to the real network address of the service.

### BACKGROUND

Cloud computing refers to the hardware, system software, and applications delivered as services over the Internet. There are a number of types of cloud computing solutions that have been developed. Platform-as-a-Service (PaaS) is a category of cloud computing solutions that facilitates the development and deployment of on-demand applications and services. PaaS is a growing technology space offering possibilities for optimization of information technology (IT) spending. It provides facilities required to support the lifecycle of applications and services, accessible through the Internet. Applications may run as a Software-as-a-Service (SaaS) on the infrastructure that is provided through the PaaS solution. Virtual Machines (VMs) are used as a standard for object deployment in cloud environment.

A PaaS solution may give application developers the tools to design, develop, test, deploy and host their software applications, as well as use provided application services and infrastructure. In addition, service providers may provision services on existing PaaS offerings for consumption by applications running on the PaaS offerings. When an application is built on top of a PaaS offering, the application may consume available services that may either be provided by the PaaS provider or by external service vendors. The application may use the provided services to store data, to communicate with other systems, to handle authentication, to collect end user feedback for the application, etc. Services are usually hosted on VMs that are different from those hosting applications. Also, services may be in different network segments and may be isolated from the rest of the cloud infrastructure. Applications access provided services through a communication protocol and use the provided libraries.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary environment for providing a secure remote consumption of a platform service by an application though a proxy server, according to one embodiment.

FIG. 2 is a flow diagram illustrating a process for providing a secure consumption of a platform service by an application though a proxy server, according to one embodiment.

FIG. 3 is a block diagram illustrating an exemplary cloud environment for providing a secure consumption of a cloud platform service by an application instantiated on a cloud platform, according to one embodiment.

FIG. 4 is a block diagram illustrating an exemplary environment for providing a secure consumption of a cloud platform service by an application through a Hypertext Transfer Protocol (HTTP) proxy server, remotely communicating with the cloud platform service, according to one embodiment.

FIG. 5 is a flow diagram illustrating a process for a secure remote consumption of a platform service by an application through a proxy server, according to one embodiment.

FIG. 6 is a block diagram illustrating a computing environment, according to an embodiment.

### DETAILED DESCRIPTION

Embodiments of techniques for providing secure consumption of a platform service by an application through a proxy server are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A PaaS solution may provide a set of platform services which can be used by application instances. Platform services may be services that are provided by the platform itself (or internal services) and/or external services that are provided by a service vendor provisioning the external services on the PaaS solution. Examples of a platform service may be a document service for managing documents and data, a connectivity service for reliable and easy-to-consume access to business systems either running on premise or on cloud, an identity service for handling the identity management and authentication at applications that are deployed and started on the PaaS solution, etc. When an application instance provisioned on the PaaS solution consumes a platform service, the application may perform a remote communication with a service virtual machine (VM), where a platform service instance is available for consumption. The application may connect with the platform service and request execution of tasks to be performed by the platform service. For example, the application may request from the platform service to download a specific document from a cloud storage as per user requested details. The communication between the application and the platform service is required to be secured having mutual authentication. The programming code of the application may include fragments related to securing the consumption of the platform service and taking care of handling certificates during the authentication. In such a manner, the application manages the complexity of handling secured consumption of the platform service. As an alternative, the tasks related to handling security aspects of the communication between the application and the platform service may be performed by a proxy server connected to the application.

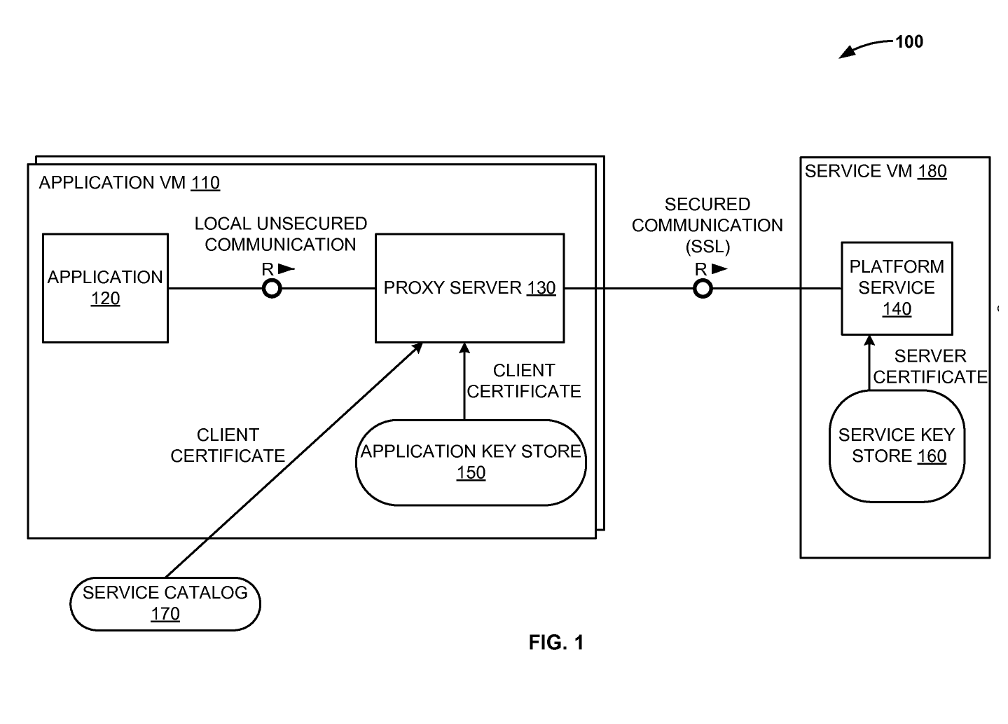

FIG. 1 is a block diagram illustrating exemplary environment 100 for providing a secure remote consumption of a platform service 140 by application 120 though proxy server 130, according to one embodiment. The proxy server 130 may be instantiated on application VM 110 to manage security related tasks associated with handling remote communication between the application 120 and the platform service 140. The application 120 is running on the application VM 110. In one embodiment, other instances of the application 120 may run on other application VMs. As a result a number of instances of the application 120 may exist and scale requests, e.g. user requests. The application VM 110 may provide required runtime infrastructure to run the application 120. In one embodiment, the application VM 110 may host a number of applications, apart from the application 120. In one embodiment, the application 120 consumes platform service 140. For example, when the application 120 is invoked to provide functionality to an end user, the platform service 140 is to be consumed. The application 120 communicates with the proxy server 130 to request secure consumption of the platform service 140. The communication between the application 120 and the proxy server 130 is local unsecured communication. The proxy server 130 may only listen to local requests and may not be contacted outside on the application VM 110. Therefore, applications that are not running on the application VM 110 may not communicate with the proxy server 130. Further, the proxy server 130 may be designated to serve only requests sent by the application 120.

In one embodiment, the proxy server 130 receives the request from the application 120, which for example requests downloading of a document named “XYZ.docx” from a storage location. The application 120 is developed in such a manner that in the programming code it is referred to the platform service 140 by calling an Application Programming Interface (API) provided by the platform service 140. The application 120 uses methods provided by the API of the platform service 140. The proxy server 130 handles the request for downloading by transforming it according to the platform service 140 and performing secured remote communication with the platform service 140. The platform service 140 is hosted on service VM 180. The proxy server 130 remotely connects with the platform service 140 to send a second request corresponding to the first received request by the application 120. The application 120 provides information related to identification of the platform service 140. In one embodiment, the identification of the platform service may be provided to the proxy server 130 as a host name, and therefore the identification used by the application 120 may follow restrictions for defining a host name. The identification may be a human-readable name that corresponds to a reference address of the platform service 140. The application 120 does not know a real network address for the platform service 140. The naming of the identification used by the application 120 to refer to the platform service 140 may be restricted to a limited set of characters or symbols. The restrictions may define that characters or symbols such as “@”, “_”, etc are not allowed for insertion.

In one embodiment, the second request is a modification of the first request after processing information received with the first request. With the second request, the proxy server 130 securely communicates with the platform service 140 and consumes features and/or resources provided by the platform service 140 as requested by the application 120 with the first request. The proxy server 130 generates the second requests by determining a real network address corresponding to the identification of the platform service 140 as received with the first requests. The determination of the real network address may be performed by the proxy server 130 by searching in service catalog 170 storing a mapping between the identification of the platform service 140 and the real network address. The service catalog 170 may further store other mappings related to identifications of platform services that may be accessible by the application 120. In one embodiment, the mappings may be stored in form of a table. The service catalog 170 may be on a storage accessible by the proxy server 130. In one embodiment, the service catalog 170 may be on the application VM 110. In another embodiment, the service catalog 170 may be on a network share.

The communication between the proxy server 130 and the platform service 140 is secured with encryption and both parties are mutually authenticated. The authentication between the proxy server 130 and the platform service 140 may be based on certificates. Application key store 150 may be in connection with the proxy server 130 to store a certificate associated with the application 120. Service key store 160 may be in connection with the platform service 140 to store a certificate associated with the platform service 140. During the secure communication between the proxy server 130 and the platform service 140 to provide consumption of the platform service 140 by the application 120, certificates are exchanged and verified by both parties in the communication. The proxy server 130 has access to a private key related to the certificate associated with the application 120 that may be used for decrypting encrypted information received by the platform service 140 during the secure communication. The private key may be stored in the application key store 150. The platform service 140 has access to a private key related to the certificate associated with the platform service 140 that may be used for authentication of the platform service 140 at the proxy server 130 and/or for decrypting encrypted information exchanged with the proxy server 130 during the secure communication. The private key may be stored in the service key store 160.

The encryption of sent information during secured communication may be performed by encrypting with a public key associated with the targeted side in the communication. The public key of a party in the communication is received with the exchange of certificates, as a certificate includes the public key and some other content related to the entity providing the certificate. For example, encrypted information is sent from the proxy server 130 and from the platform service during the communication between the proxy server 130 and the platform service 140. The encryption is used for securing the communication. The encryption may be performed with the use of a public key of the proxy server 130 and a public key of platform service 140, accordingly.

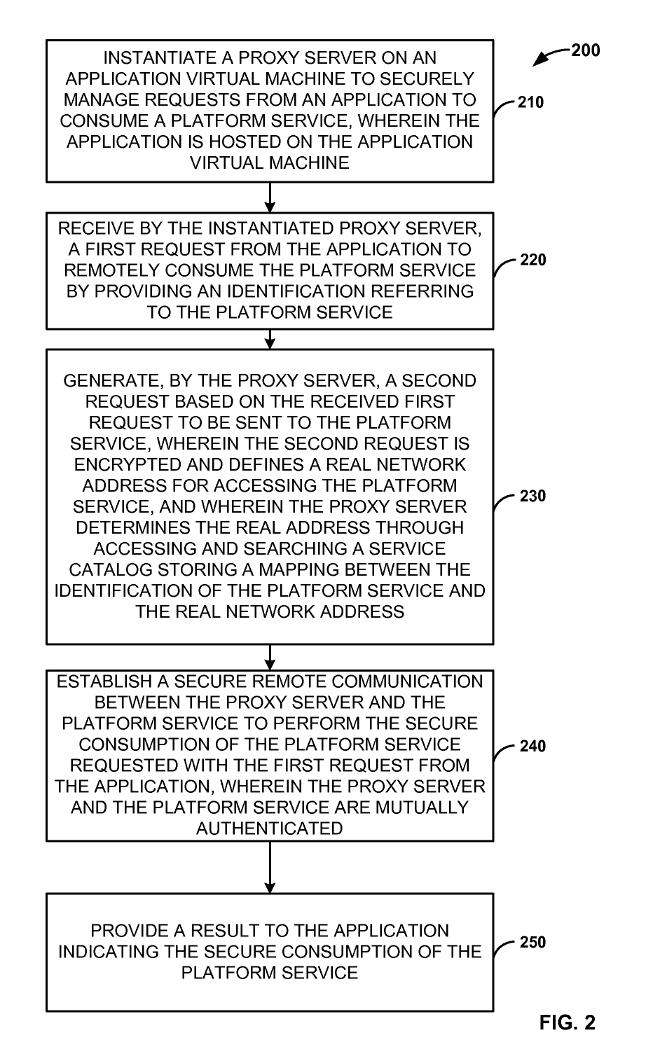

FIG. 2 is a flow diagram illustrating process 200 for providing a secure consumption of a platform service by an application though a proxy server, according to one embodiment. At 210, the proxy server is instantiated on an application VM. The proxy server may secure the communication between the application and the platform service, for example, when the application consumes features and resources provided by the platform service. The proxy server securely manages requests received by the application for platform service consumption. The application is instantiated on the application VM, where the proxy server is also hosted. In one embodiment, the application VM may be provided by a cloud platform that provides runtime infrastructure, e.g., together with other tools, features, services, etc. that may be used by applications hosted on the cloud platform. At 220, the instantiated proxy server receives a first request from the application to remotely consume the platform service. The application may provide with the first request information about identification of the platform service.

At 230, the proxy server generates a second requests based on the received first request, that is sent to the platform service. The proxy server modifies the information received with the first request. The proxy server encrypts the communication with the platform service and substitutes the identification of the platform service, as received by the application with the first request, with a real network address for the platform service. The proxy server accesses a service catalog that stores data related to a mapping between the identification of the platform service and the real network address. The service catalog may further store other mappings associated with other platform services that are available for consumption by the application (and possibly by other applications). The proxy server searches the service catalog to determine the real network address to generate the second request to the remote platform service. With the generated second request, the proxy server remotely calls the real network address of the platform service and provides consumption of the platform service to the application as requested with the first request.

At 240, a secure remote communication between the proxy server and the platform service is established to perform secure consumption of the platform service. The proxy server and the platform service are mutually authenticated, for example, based on certificates. The proxy server and the platform service may further perform authorization steps for verification of rights of the application to consume the platform service. At 250, a result of the secure consumption of the platform service is provided to the application. In one embodiment, the application may further provide details related to the consumption to an end user, e.g., through an application user interface (UI).

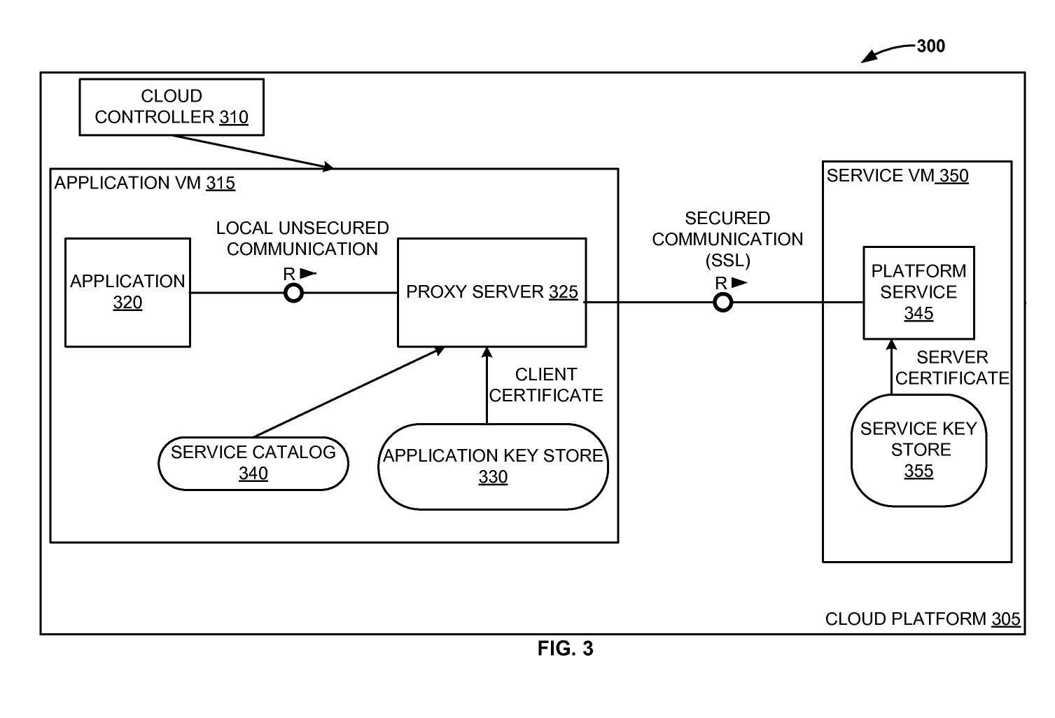

FIG. 3 is a block diagram illustrating exemplary cloud environment 300 for providing a secure consumption of cloud platform service 345 by application 320 instantiated on cloud platform 305, according to one embodiment. The application 320 runs as instantiated as a SaaS on an infrastructure that is provided by the cloud platform 305. In one embodiment, the cloud platform 305 may further integrate an Infrastructure-as-a-Service (IaaS) that offers computing resources in the form of physical or VMs, data storage, networks, load balancers, etc. In another embodiment, the cloud platform 305 may provide the computing resources. The cloud platform 305 may comprise components that create an environment for provisioning and running applications. An application may be deployed, started, stopped, and undeployed on the cloud platform 305. An application may run in one or more application processes. By having multiple processes where the application runs, the load of the application may be distributed and failover capabilities may be provided.

In one embodiment, the cloud platform 305 includes platform controller 310 that takes care for instantiating application instances on VMs available to the cloud platform 305. The platform controller 310 may be a cloud platform controller. The platform controller 310 may select a VM, such as application VM 315, from a pool with VMs to deploy and start an instance of the application 320 on the application VM 315. The platform controller 310 may further instantiate proxy server 325 on the application VM 315. The platform controller 310 may instantiate the application 320 and the proxy server 325 in a different order of instantiation. For example, a sequence where first the application 320 is instantiated and then the proxy server 325 is instantiated is possible. During instantiating the application 320 on the application VM 315, the platform controller 310 may provide port 427 as a communication endpoint for addressing calls from the application 320 to the proxy server 325. The application 320 may store the provided details for the port 427 in application's memory. The application 320 may be developed in such a manner that the application 320 consumes the platform service 345 that is available on the cloud platform 305. The platform service 345 may be provided on the cloud platform 305 by a service vendor, which may be a different entity from the vendor of the cloud platform 305. Additionally, the platform service 345 may be provided by the same vendor as the vendor of the cloud platform 305 and be part of the cloud platform 305 as a whole.

In one embodiment, the application 320 communicates with the proxy server 325 to request that the proxy server 325 handles the secure communication with the platform service 345. The application 320 may not have information about a real address of the platform service 345. The application 320 refers to the platform service 345 by an identification. The identification may be series of characters for uniquely referring to the platform service 345. The identification may be a human-readable label. The proxy server 325 takes care of performing a secure remote connection with the platform service 345 over the network. The application 320 may communicate with the proxy server 325 using HTTP. The proxy server 325 may be an HTTP proxy server that receives the HTTP request from the application providing details for consuming the platform service 345. The request sent by the application 320 may define an identification of the platform service 345.

For example, the request sent by the application 320 may provide a Uniform Resource Locator (URL) referring the identification of the platform service 345 as provided by the application 320 as a host in the URL. Further, a port may be specified in the request in addition to the host. The application 320 may receive the port during instantiation of the application 320 by the platform controller 310 as an environment variable associated with the application VM 315. In another embodiment, different approaches for providing the port to the application 320 may be utilized. For example, if the application 320 is a Java application, it may be possible to inject the port as a java property into the application 320.

In one embodiment, the platform controller 310 may generate a service catalog 340 on the application VM 315 that is accessible by the proxy server 325. The service catalog 340 includes information about platform services that are accessible by the application 320. The service catalog 340 stores mappings between identifications and platform services, as used by the application 320, and real network addresses where the platform services may be located on the network in the cloud platform 305. In another embodiment, the service catalog 340 may further store mappings between identification and other service, which are not provided by the cloud platform 305, and which are hosted outside of the cloud platform 305. When the proxy server 325 receives the request for secure remote consumption of the platform service 345, the proxy server 325 uses the identification provided by the application 320 defining the platform service 345 and searches for a mapping between the provided identification and a real network address of the platform service 345 in the service catalog 340. The proxy server 325 than generates a second requests, which is a remote secured request to the platform service 345, which is instantiated on service VM 350. The service VM 350 is part of the cloud platform 305. The proxy server 325 directs the second generated request to the real network address as determined based on searching in the service catalog 340 in an encrypted manner. The proxy server 325 and the platform service 345 mutually authenticate themselves, for example through certificates. The certificates may be generated based on public keys and additional information about the subject of certification. Therefore, a certificate may include a public key and additional content, describing the entity possessing the certificate. The proxy server 325 provides a certificate to the platform service 345 that is generated based on a public key associated to the application 320 that is stored in an application key store 330. Respectively, the platform service 345 provides a certificate to the proxy server 325 that is generated based on a public key associated to the platform service 345 that is stored in service key store 355. The certificates are verified based on verification of trust related to signatures of the exchanged certificates and based on verification of content part of the certificates. Further, authorization steps may be performed by the platform service 345 and the proxy server 325. The authorization between the platform service 345 and the proxy server 325 may be performed and access for consumption of the platform service 345 by the application 320 may be granted after successful authorization. In another embodiment, authorization steps may not be performed. After authentication of the application 320 with the platform service 345 through the proxy server 325, access to consuming resources provided by the platform service 345 may be granted.

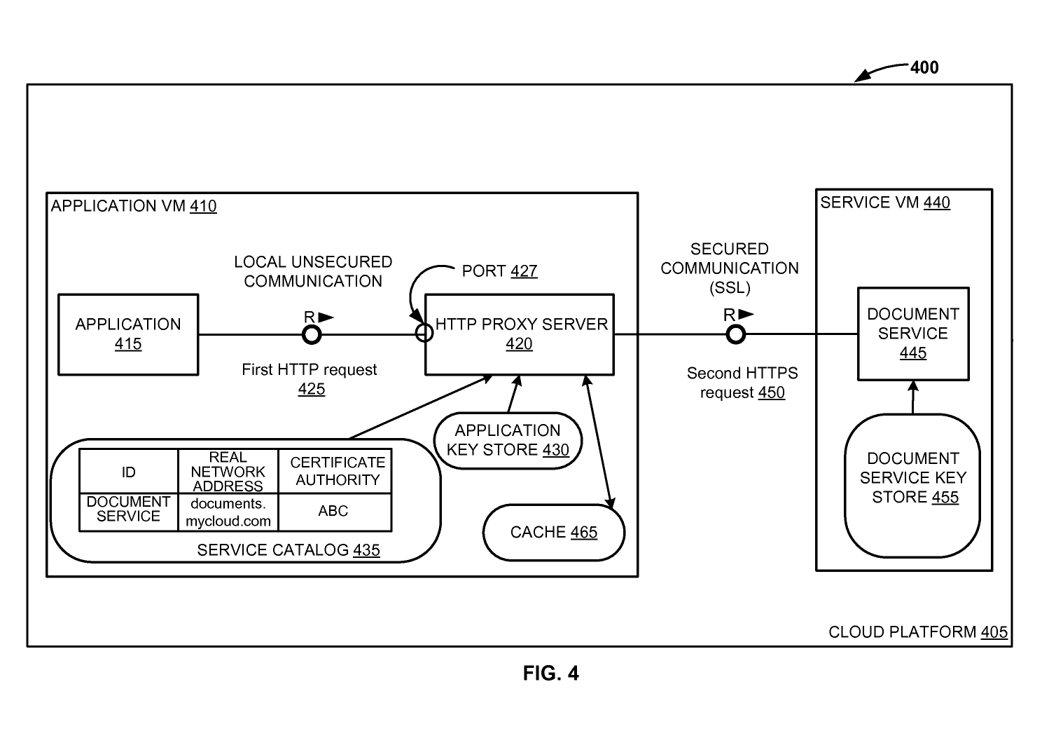

FIG. 4 is a block diagram illustrating exemplary environment 400 for providing a secure consumption of a cloud platform service by application 415 through HTTP proxy server 420 remotely communicating with the cloud platform service, according to one embodiment. Cloud platform 405 provides application VM 410 and service VM 440 that are available for hosting platform applications and cloud platform services, which are consumed by the platform applications. Provided features by the cloud platform services are incorporated into the behavior of the platform applications to serve clients requests targeted to the platform applications. The application 415 is provisioned on the application VM 410. The application VM 410 hosts the HTTP proxy server 420, which is instantiated to manage requests from application, including the application 415, for secure consumption of cloud platform services, such as document service 445. The document service 445 is a cloud provided service, which is provisioned on the service VM 440. The application 415 communicates with the HTTP proxy server 420 through a local unsecured communication over HTTP. The HTTP proxy server 420 may be configured to accept requests that are internal for the application VM 410, and therefore the HTTP proxy server 420 may not be accessed from a remote entity, that requires secure communication. The communication between the application 415 and the HTTP proxy server 420 is unsecured. The application 415 sends a first HTTP request 425 to the HTTP Proxy Server 420 for consumption of the document service 445. The first HTTP request 425, for example, is from a user to upload a file and store it for future accessing. For example, the file may be with a name “mydoc.docx”. In one embodiment, the first HTTP request 425 may be received by the application 415 through a user interaction with a UI of the application 415. The document service 445 may be a service that provides storage and retrieval of files on the cloud platform 405. Additionally, the document service 445 may be further operable to organize stored files in a hierarchical structure with folders, to associate metadata with stored content and access rights associated with that metadata, to handle versioning of content, etc. The first HTTP request 425 as received by the application 415 to upload the file “mydoc.docx” is transmitted to the HTTP proxy server 420 for requesting the desired uploading by the document service 445 on a network storage. The application 415 is developed in such a manner that it utilizes the exposed API of the document service 445 and may consume the provided services by the document service 445 to upload file “mydoc.docx” on the designated network storage.

In one embodiment, the first HTTP request 425 provides an URL for accessing the document service. The URL includes an identification of the document service 445 as provided by the application 415. The identification may be a label, or a string that is used as a host name in the URL and the identification complies with restrictions and requirements defined for a host name. The first HTTP request 425 may be such as “http://documentservice/api/v1/documents/mydoc.docx”, where the host name is the identification of the document service 445 that the application 415 uses for referring. If the application 415 requests consumption of another platform service, a similar or analogous HTTP request may have a structure such as “http://<host>{xport>}/<parameters>”, where the <host> may be replaces by an identification of the requested platform services as used by the application 415. With the first HTTP request 425, additional parameters may be transferred through the HTTP Proxy Server 420 that are related to the requested consumption of the document service 445. Using a port in the HTTP request 425 may be optional, and the application 415 may know that port, for example, received as an environment variable during the instantiation of the application 415 on the application VM 410. The HTTP Proxy Server 420 receives the first HTTP request 425 and searches for a corresponding real network address for the received identification of the document service 445. The HTTP Proxy Server 420 accesses service catalog 435 that stores mappings between identifications of platform services and real network addresses for these platform services. The HTTP Proxy Server 420 searches for a real network address that maps the identification to the document service 445, which is “documentservice”. The service catalog 435 find a corresponding real network address, for example—documents.mycloud.com, which may be used for generating second Hypertext Transfer Protocol Secure (HTTPS) request 450 from the HTTP Proxy Server 420 to the document service 445. The HTTP Proxy Server 420 generates the second HTTPS request 450 by encrypting the communication and using a secured communication protocol, such as the HTTPS protocol. The communication between the HTTP proxy Server 420 and the document service 445 uses the HTTPS protocol, instead of the HTTP protocol used during the first HTTP request 425. The second HTTPS request 450 may be generated based on the first HTTP request 425 by replacing the identification of the document service “documentservice” with the real network address found in the service catalog 435—“documents.mycloud.com”. The second HTTPS request 450 may be a post requests such as: “post https://documents.mycloud.com/api/v1/documents/mydoc.docx”. The HTTP Proxy Server 420 calls the document service 445 with the second HTTPS request 450.

In one embodiment, a Secure Sockets Layer (SSL) networking protocol may be used during the communication between the HTTP proxy server 420 and the document service 445. The SSL may run above a Transmission Control Protocol/Internet Protocol (TCP/IP protocol), which is responsible for transportation and routing of data over a network, namely between the HTTP proxy server 420 and the document service 445. The SSL networking protocol may be utilized also with the embodiments suggested in FIG. 3, where the proxy server 325 may be not only an HTTP proxy server (such as the HTTP proxy server 420), but a proxy server following an alternative network protocol. During the communication between the HTTP Proxy server 420 and the document service 445, mutual authentication is performed. The mutual authentication based on SSL may be performed through verification of certificates.

In one embodiment, the HTTP proxy server 420 has access to application key store 430 that includes a certificate generated for the application 415. In one embodiment, these certificates may be generated by a cloud controller, such as the platform controller 310, FIG. 3. The certificate of the application 415 stored in the application key store 430 is provided to the document service 445 by the proxy server 420 during the authentication steps. The document service 445 may have access to document service key store 455, where a certificate for authentication for the document service 445 is stored. In one embodiment, the certificate of the application 415 and the certificate of the document service 445 may be created based on a generated public key for the application 415 and the document service 445. Further, the application key store 430 may further store a key pair for the application 415 that includes a public key and a private key generated for the application 415. The certificate for the application 415 may be based on the public key from the generated key pair. Further, the certificate of the document service 445 stored in the document service key store 160 is provided to the HTTP proxy server 420. Verification of certificates together with verification of content of the certificates may be performed. The verification of certificates may be in form of verification of a signature of a certificate authority used for signing a given certificate. A certificate authority may be an entity that issues digital certificates that certifies an ownership of a public key by the subject of the certificate. A certificate authority may be a trusted third party that is trusted by both sides of a communication that is secured with authentication based on certificates. A signature of the certificate authority used for signing the certificate of the document service 445 is verified by the HTTP proxy server 420 though a certificate authority certificate known by the proxy server 420. The certificate authority certificate used for the verification may be stored in the service catalog 435 and be associated with the mapping between the identification of the document service 445 used by the application 415 and the real network address of the document service 445 as defined in the service catalog 435. For example, the service catalog 435 may include information about a certificate authority that is trusted by the application 415, which may be named “ABC”. Respectively, a signature of the certificate authority used for signing the certificate of the application 415 is verified by the document service 445 though a certificate authority certificate known by the document service 445. In one embodiment, the certificate of the application 415 may be signed with a certificate of a cloud controller, such as the platform controller 310. The document service 445 may search, for example in the document service key store 455 to determine if he trusts the application 415 by verifying his trust in the signing authority of the certificate—the cloud controller. The verification may be performed through comparing the signing certificate of the cloud controller with a set of public keys corresponding to trusted authorities defined for the document service 445.

The HTTP proxy server 420 authenticates with the document service 445 and provides to the application 415 the requested consumption of the document service 445. The request for uploading the file “mydoc.docx” is successfully completed by the document service 445 which stores the file “mydoc.docx”, for example on a file share on the service VM 440. The file share may be dedicated to an account of a particular user of the application 415 that requested the uploading.

In one embodiment, the HTTP proxy server 420 may further be responsible for performing local caching on the application VM 410 for example on a local cache storage, such as a cache 465 storage. The HTTP proxy server 420 may perform operations to store resources requested by the application 415 on a regular basis. In other words, the application 415 may send a number of requests to the HTTP proxy server 420 with different requests to the document service 445. For example, after sending a request for uploading the file “mydoc.docx” by the document service 445, the application 415 may send one or more requests to the HTTP proxy server 420 to retrieve that file from the storage where the document service 445 uploaded the file. If the requests for downloading that file happens frequently and meets criteria of a minimum number of requests, then the HTTP proxy Server 420 may store that file in the cache 465 for a limited time. The limited time may be configured and changed on a regular basis and may be associated with requirements define by the application 415. In an embodiment, if a resource is requested 3 times, the resources may be stored by the HTTP Proxy server 420 on the cache 465 and be maintained there for one day. Having the example with file “mydoc.docx”, if it meets the criteria of being requested 3 times by the application 415, then it will be maintained in the cache 465 for 24 hours. A next request, identical to the previous request with same parameters as used before, may be sent by the application 415 for downloading the file “mydoc.docx” to the HTTP Proxy Server 420, for example within the defined 24 hours (1 days) when the file is maintained in the cache 465. In such cases, the HTTP Proxy Server 420 may search the file “mydoc.docx” in the cache 465 and determine that such a file is stored there. When the file is in the cache 465, the file may be sent to the application 415 by the HTTP Proxy server 420, without performing a second call to the document service 445, such as the second HTTP request 450. In such manner, the caching tasks are handled by the HTTP Proxy Server 420 and not by the application 415 or other runtime components. The existence of a caching mechanism may improve the performance of the provided services for consumption by applications that are provisioned and available on the cloud platform 405.

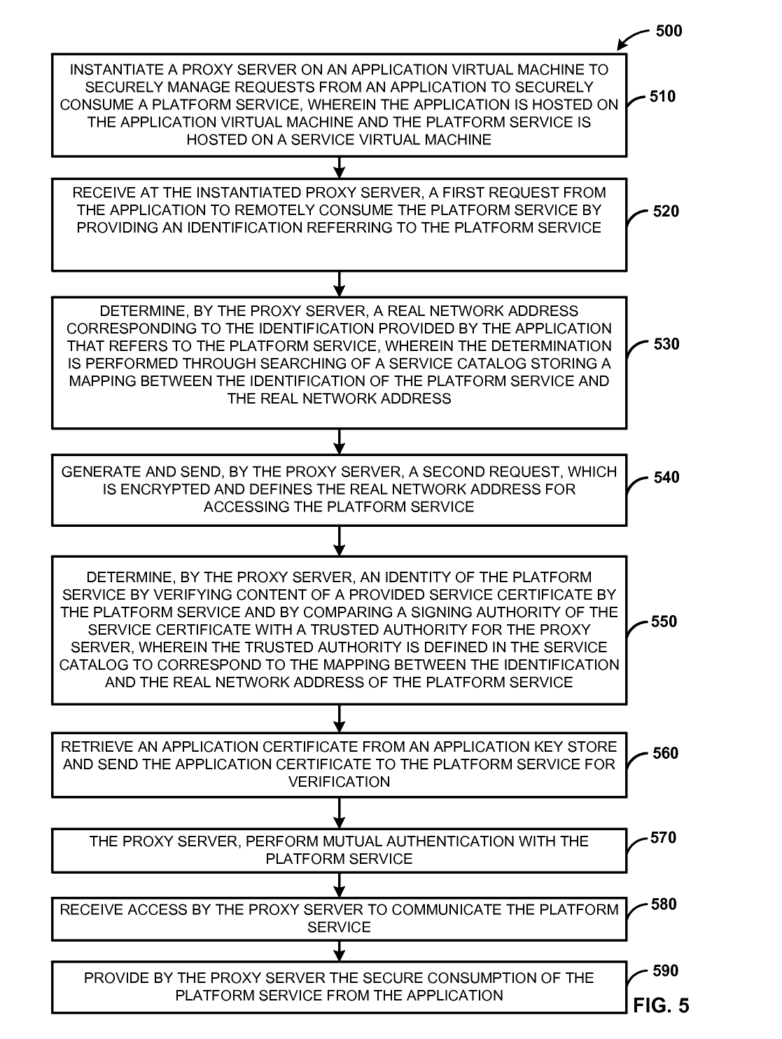

FIG. 5 is a flow diagram illustrating process 500 for a secure remote consumption of a platform service by an application through a proxy server, according to one embodiment. At 510, a proxy server is instantiated on an application VM to securely manage requests from an application to securely consume a platform service provided on a service VM. The proxy server is hosted on the same application VM which hosts the application. The application may be such as the application 320, FIG. 3 or the application 415, FIG. 4. The proxy server may be such as the proxy server 325, FIG. 3 or the HTTP proxy server 420, FIG. 4. The application and the platform service may be running on a cloud platform that provides the application VM and the service VM. At 520, the proxy server receives a first HTTP request 425 from the application to remotely consume the platform service. The application provides to the proxy server an identification of the platform services. Examples of an identification may be such as the identification described on FIG. 4—“documentservice”. With the identification, the application unique refers to the platform services that is about to be consumed. At 530, the proxy server determines a real network address corresponding to the identification received by the application. The determination is performed through searching of a service catalog, such as the service catalog 340, FIG. 3, or service catalog 435, FIG. 4. The service catalog maintains a mapping between the identification of the platform service as used by the application and the real network address. The service catalog may be specifically created for the application, and may be accessible only by the proxy server that handles the secure communication between the application and the platform service. The service catalog may further store information related to other platform services that are available for consumption for the application. The proxy server may only have reading rights for the service catalog, and may not change data stored there.

At 540, the proxy server generates and sends a second requests which is encrypted and defines the real network address for accessing the platform service. The generation of the second request may be such as the described generation of a request between the proxy server and the platform service in FIG. 1, FIG. 2, FIG. 3, and FIG. 4. In one embodiment, after sending the second request by the proxy server, an exchange of certificates may be performed by the proxy server and the platform service. At 550, the proxy server determines an identity of the platform service by verifying content of a provided service certificate by the platform service and by comparing a signing authority of the provided service certificate with a trusted authority for the proxy server. The proxy server receives the service certificate for verification of the identity of the platform service. The trusted authority may be an entity that the application trusts when determining an identity of a platform service. The trusted authority may be a certificate authority that is listed in the service catalog and is associated with a specific platform service. At 560, the proxy server retrieves an application certificate from an application key store that is verified by the platform service. The proxy server further retrieves a private key associated with the application certificate from the application key store. The private key and the application certificate are used to verify the identity of the proxy server, and respectively the application, when communicating with the platform service. At 570 the proxy server mutually authenticates with the platform service. The proxy server performs the mutual authentication with the platform service through verification of certificates. The verification of the application certificate may be performed based on verification of the certificate of the signing authority of the application certificate. The verification of the service certificate may be performed based on verification of the certificate of the signing authority of the service certificate. During the verification of certificates, mutual trust in the identity of the parties in the communication, namely the proxy server and the platform service is confirmed. At 580, the proxy server receives access to communicate with the platform service and provide consumption of the platform service to the application. At 590, the proxy server provides secure consumption of the platform service from the application.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

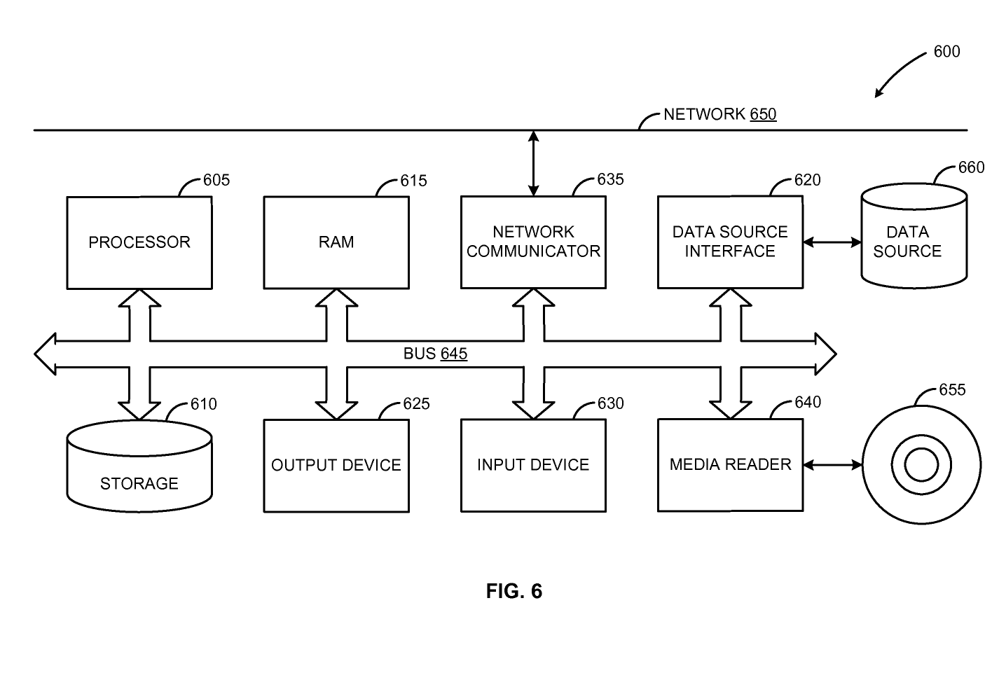

FIG. 6 is a block diagram of an exemplary computer system 600. The computer system 600 includes a processor 605 that executes software instructions or code stored on a computer readable storage medium 655 to perform the above-illustrated methods. The processor 605 can include a plurality of cores. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. According to some embodiments, such as some in-memory computing system embodiments, the RAM 615 can have sufficient storage capacity to store much of the data required for processing in the RAM 615 instead of in the storage 610. In some embodiments, all of the data required for processing may be stored in the RAM 615. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to provide a secure consumption of a platform service by an application, the method comprising:
instantiating a proxy server on an application virtual machine to securely manage requests from the application to consume the platform service, wherein the application is hosted on the application virtual machine;
receiving, by the instantiated proxy server, a first request from the application to consume the platform service, the first request providing an identification referring to the platform service;
determining a real network address corresponding to the identification provided with the first request that refers to the platform service, wherein the real network address is determined through accessing and searching of a service catalog storing a mapping between the identification of the platform service and the real network address;
generating, by the proxy server, a second request based on the received first request to be sent to the platform service, wherein the second request is encrypted and defines the real network address for accessing the platform service; and
establishing a secure communication between the proxy server and the platform service to perform the secure consumption of the platform service requested with the first request from the application, wherein the proxy server and the platform service are mutually authenticated.

2. The method of claim 1, wherein the proxy server and the platform service are mutually authenticated during establishing of the secure communication.

3. The method of claim 1, further comprising:
providing a result to the application indicating the secure consumption of the platform service.

4. The method of claim 2, wherein the mutual authentication between the proxy server and the platform service is performed based on verification of certificates.

5. The method of claim 2, wherein establishing the secure communication between the proxy server and the platform service further comprises:
the proxy server determining an identity of the platform service based on a provided service certificate by the platform service;
retrieving an application certificate and a private key associated with the application certificate from an application key store, wherein the application certificate is verified by the platform service during the mutual authentication between the proxy server and the platform service; and
receiving access to the platform service to provide the secure consumption of the platform service by the application.

6. The method of claim 5, wherein determining the identity of the platform service is performed by verifying the content of the service certificate and by comparing a signing authority of the provided service certificate with a trusted authority for the proxy server, wherein the trusted authority is defined in the service catalog to correspond to the mapping between the identification and the real network address of the platform service.

7. The method of claim 1, wherein the platform service is a cloud platform service provided on a cloud platform, and wherein the cloud platform provides the application virtual machine.

8. The method of claim 1, wherein the proxy server and the application are isolated in a process on the application virtual machine to share physical and virtual resources.

9. The method of claim 1, further comprising:
the proxy server, communicating with a local cache storage to:
determine whether a resource requested with the first request is stored in the local cache storage; and
provide the resource to the application, when the resource is found in the local cache storage.

10. A computer system to provide a secure consumption of a platform service by an application, the system comprising:
a processor; and
a memory in association with the processor storing instructions related to a platform controller operable to:
determine an application virtual machine for instantiating an application;
instantiate the application on the application virtual machine;
instantiate a proxy server on the application virtual machine to securely manage requests from the application to consume the platform service, wherein the proxy server is further operable to:
receive a first request from the application to consume the platform service, the first request providing an identification referring to the platform service, wherein the platform service is remotely accessible on a service virtual machine;
determine a real network address corresponding to the identification provided with the first request that refers to the platform service, wherein the real network address is determined through accessing and searching of a service catalog storing a mapping between the identification of the platform service and the real network address;
generate a second request based on the received first request to be sent to the platform service, wherein the second request is encrypted and defines the real network address for accessing the platform service; and
establish a secure communication between the proxy server and the platform service through sending the generated second request to perform the secure consumption of the platform service as requested with the first request, wherein the proxy server and the platform service are mutually authenticated.

11. The system of claim 10, wherein the proxy server is further operable to:
provide a result to the application indicating the secure consumption of the platform service.

12. The system of claim 10, wherein the platform service is a cloud platform service provided on a cloud platform, and wherein the cloud platform provides the application virtual machine and the service virtual machine.

13. The system of claim 10, wherein the proxy server is an HTTP proxy server.

14. The system of claim 10, wherein establishing the secure communication between the proxy server and the platform service further comprises:
determining an identity of the platform service by verifying content of a service certificate provided by the platform service and by comparing a signing authority of the service certificate with a trusted authority for the proxy server, wherein the trusted authority is defined in the service catalog to correspond to the mapping between the identification and the real network address of the platform service;
retrieving an application certificate from an application key store, wherein the application certificate is verified by the platform service; and
receiving access to the platform service to provide the secure consumption of the platform service by the application.

15. A non-transitory computer-readable medium storing instructions to provide a secure consumption of a platform service by an application, which when executed cause a computer system to:
instantiate a proxy server on an application virtual machine to securely manage requests from the application to consume the platform service, wherein the application is hosted on the application virtual machine;
receive by the instantiated proxy server, a first request from the application to consume the platform service, the first request providing an identification referring to the platform service;
determine a real network address corresponding to the identification provided with the first request that refers to the platform service, wherein the real network address is determined through accessing and searching of a service catalog storing a mapping between the identification of the platform service and the real network address;
generate, by the proxy server, a second request based on the received first request to be sent to the platform service, wherein the second request is encrypted and defines the real network address for accessing the platform service;
establish a secure communication between the proxy server and the platform service through sending the generated second request; and
the proxy server, perform mutual authentication with the platform service to provide access and to securely consume the platform service by the application through the proxy server.

16. The computer-readable medium of claim 15, wherein the platform service is a cloud platform service provided on a cloud platform, and wherein the cloud platform provides the application virtual machine.

17. The computer-readable medium of claim 15, wherein the proxy server is an HTTP proxy server.

18. The computer-readable medium of claim 15, further comprising instructions, which when executed by a computer, cause the computer to:
provide a result to the application indicating the secure consumption of the platform service.

19. The computer-readable medium of claim 15, wherein the mutual authentication between the proxy server and the platform service is performed based on verification of certificates.

20. The computer-readable medium of claim 18, wherein the instructions related to establishing the secure communication between the proxy server and the platform service, further comprises instructions to:
determine, by the proxy server, an identity of the platform service by verifying content of a provided service certificate by the platform service and by comparing a signing authority of the provided service certificate with a trusted authority for the proxy server, wherein the trusted authority is defined in the service catalog to correspond to the mapping between the identification and the real network address of the platform service; and
retrieve an application certificate from an application key store, wherein the application certificate is verified by the platform service during the mutual authentication between the proxy server and the platform service.
